(19) United States
(12) Patent Application Publication
(10) Pub. No.: US 2025/0165202 A1
(43) Pub. Date: May 22, 2025

(54) DISPLAY APPARATUS, IMAGE PROCESSING APPARATUS, AND DISPLAY CONTROL METHOD OF ADDITIONAL DISPLAY

(71) Applicant: SHARP KABUSHIKI KAISHA, Sakai City (JP)

(72) Inventor: Kenji Ogasawara, Sakai City (JP)

(21) Appl. No.: 18/941,302

(22) Filed: Nov. 8, 2024

(30) Foreign Application Priority Data
Nov. 17, 2023 (JP) 2023-196004

(51) Int. Cl. G06F 3/14; G06F 3/0488

(52) U.S. Cl. CPC G06F 3/14; G06F 3/0488

(57) ABSTRACT

This display apparatus includes: a display that displays an operation screen containing one or more objects; and one or more controllers that, based on a user operation made with respect to any of the one or more objects, control a display of an additional display corresponding to the at least one of the one or more object. The one or more controllers change a display mode of the additional display when the display of the additional display overlaps a restricted region that restricts the display of the additional display.

### BACKGROUND OF THE INVENTION

### Field of the Invention

The present disclosure relates to a display apparatus and the like.

### Description of the Background Art

There is known a technique that displays information (supplementary information) about an object, such as a button or an icon that is displayed on a screen of a display apparatus, as a result of performing an operation such as a mouseover, or pressing and holding the object. In the present disclosure, a display related to such information is referred to as an additional display.

For example, as a conventional technique, it is disclosed that when a tooltip showing information related to a target item (object) selected by a user is displayed, if the display of the tooltip covers the target item, the display position of the target item is adjusted such that the display of the tooltip does not overlap the target item.

The present disclosure has an object of providing a display apparatus and the like that is capable of maintaining the visibility of an object by appropriately controlling a display mode of an additional display.

### SUMMARY OF THE INVENTION

In order to solve the problem described above, a display apparatus according to the present disclosure includes: a display that displays an operation screen containing one or more objects; and one or more controllers that, based on a user operation made with respect to at least one of the one or more objects, control a display of an additional display corresponding to the at least one of the one or more objects; wherein the one or more controllers change a display mode of the additional display when the display of the additional display overlaps a restricted region that restricts the display of the additional display.

Furthermore, an image processing apparatus according to the present disclosure includes: a display that displays an operation screen containing one or more objects; one or more controllers that, based on a user operation made with respect to at least one of the one or more objects, control a display of an additional display corresponding to at least one of the one or more objects; and an image processor; wherein the one or more controllers change a display mode of the additional display when the display of the additional display overlaps a restricted region that restricts the display of the additional display.

Moreover, a display control method of an additional display according to the present disclosure includes: controlling, based on a user operation made with respect to at least one of one or more objects displayed on an operation screen, a display of an additional display corresponding to the at least one of the one or more objects; and changing a display mode of the additional display when the display of the additional display overlaps a restricted region that restricts the display of the additional display.

According to the present disclosure, it is possible to provide a display apparatus and the like that is capable of maintaining the visibility of an object by appropriately controlling a display mode of an additional display.

### BRIEF DESCRIPTION OF THE DRAWINGS

FIG. 1 is a diagram illustrating an overall configuration of an image processing apparatus according to a first embodiment.

FIG. 2 is a functional configuration diagram of an image processing apparatus implementing a display apparatus according to the first embodiment.

FIG. 3 is a flowchart illustrating a processing flow according to the first embodiment.

FIGS. 4A to 4F are each a diagram illustrating an operation example according to the first embodiment.

FIGS. 5A and 5B are each a diagram illustrating an operation example according to the first embodiment.

FIGS. 6A to 6D are each a diagram illustrating an operation example according to the first embodiment.

FIGS. 7A to 7C are each a diagram illustrating an operation example according to the first embodiment.

FIGS. 8A and 8B are each a diagram illustrating an operation example according to the first embodiment.

FIGS. 9A and 9B are each a diagram illustrating an operation example according to the first embodiment.

FIGS. 10A and 10B are each a diagram illustrating an operation example according to the first embodiment.

FIGS. 11A to 11C are each a diagram illustrating an operation example according to the first embodiment.

FIGS. 12A and 12B are each a diagram illustrating an operation example according to the first embodiment.

FIGS. 13A and 13B are each a diagram illustrating an operation example according to the first embodiment.

FIGS. 14A and 14B are each a diagram illustrating an operation example according to the first embodiment.

FIG. 15 is a flowchart illustrating a processing flow according to a second embodiment.

FIGS. 16A and 16B are each a diagram illustrating an operation example according to the second embodiment.

FIG. 17 is a flowchart illustrating a processing flow according to a third embodiment.

### DESCRIPTION OF THE PREFERRED EMBODIMENTS

Hereinafter, embodiments of the present disclosure will be described with reference to the drawings. Note that the following embodiments are examples for describing the present disclosure, and the technical content described in the claims are not limited to that of the following description.

There is known a technique that causes information (supplementary information) about an object such as an input field or a display field, which is subjected to operation and display by a user, to be displayed as an additional display as a result of performing an operation such as a mouseover or pressing and holding the object.

For example, consider a case where a button displayed on the screen of a display apparatus such as a touch panel cannot display the complete character string of the caption due to a limitation in the number of characters that can be displayed the display frame, and an ellipsis symbol “ . . . ” is displayed to indicate that some of the characters have been omitted.

In this case, when the button is selected by the user (for example, when the button is pressed and held by the user), the display apparatus displays a tooltip, which is one form of an additional display, and displays the complete character string related to the caption. The user is capable of accurately grasping the information and function of the button by confirming the complete character string that has been displayed.

However, the objects that constitute a screen are not only objects that display an additional display in response to selection by the user. For example, the objects also include objects related to the display of important information such as the “title” of the screen, and objects that accept inputs and the like of important setting values from the user.

When an additional display is displayed overlapping such important objects, there is a problem that the user is unable to grasp accurate information and functions related to the important objects.

In the present disclosure, a display apparatus and the like that is capable of maintaining the visibility of an object by appropriately controlling a display mode of an additional display is realized with the embodiments described below.

### 1. First Embodiment

### 1.1 Functional Configuration

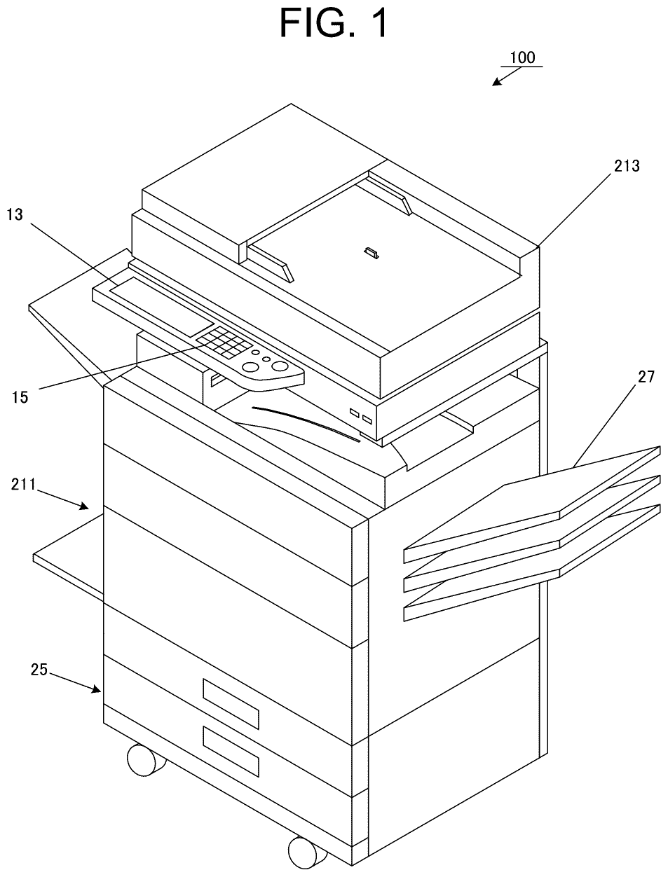

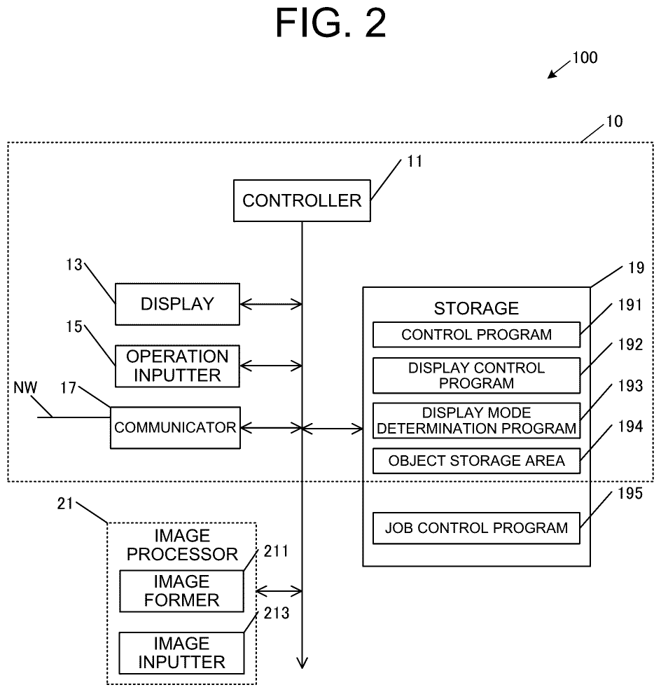

FIG. 1 is a diagram illustrating an overall configuration of a multifunction peripheral 100 serving as an image processing apparatus according to a first embodiment. FIG. 2 is a functional configuration diagram of the multifunction peripheral 100 implementing a display apparatus 10 according to the first embodiment. The multifunction peripheral 100 includes an image processor 21 in addition to the configuration of the display apparatus 10 indicated by the dotted line in FIG. 2, and stores a job control program 195 in a storage 19.

The multifunction peripheral 100 is one form of an image processing apparatus that is capable of performing various types of jobs such as printing, copying, faxing, and image transmission in a single casing. Note that, in the first embodiment, a mode of the multifunction peripheral 100 will be described as an example of the image processing apparatus. However, the image processing apparatus is not particularly limited as long as it has a configuration that implements the display apparatus 10 according to the first embodiment. For example, the image processing apparatus may be a printer, a copy machine, a fax apparatus, or the like, that are limited to each type of job function.

The multifunction peripheral 100 includes a controller 11, a display 13, an operation inputter 15, a communicator 17, a storage 19 and an image processor 21.

The controller 11 comprehensively controls the entire display apparatus 10 and multifunction peripheral 100. The controller 11 can be configured by one or more processing apparatus (such as a central processing unit (CPU) or a system on chip (Soc)). The controller 11 reads and executes various programs stored in the storage 19 to realize the functions of the programs.

The display 13 is a display member that displays various information to the user. The display 13 can be configured by, for example, a liquid crystal display (LCD), an organic electro-luminescence (EL) display, or the like. The display 13 displays operation screens according to the state of the multifunction peripheral 100 (for example, a home screen, a settings screen related to execution of each job, and a history information screen described below).

The operation inputter 15 is an input device that accepts an input of information by the user or the like. The operation inputter 15 can be configured by various input devices, including operation keys such as hardware keys or software keys, and buttons. Note that the operation inputter 15 may also be configured as a touch panel that allows inputs via the display 13. When the operation inputter 15 is configured as a touch panel, touch operations by the user made with respect to a displayed object are detected via the display 13, and coordinate information, pressure-sensitive information, and the like, on the touch panel can be acquired. In this case, examples of the input method to the touch panel that can be adopted include general methods such as a resistive film method, an infrared method, an electromagnetic induction method, and a capacitance method.

The communicator 17 includes a wired and/or wireless interface for communicating with other external terminal devices (not shown) via a network NW such as a local area network (LAN), a wide area network (WAN), the Internet, a telephone line, or a fax line. Furthermore, for example, the communicator 17 may also include an interface related to a (short-range) wireless communication technology such as Bluetooth (registered trademark), near field communication (NFC), Wi-Fi (registered trademark), ZigBee (registered trademark), Infrared Data Association (IrDA), or wireless universal serial bus (USB).

The storage 19 is one or more storage devices that store various programs and various types of data required for the operation of the display device 10 and the multifunction peripheral 100. The storage 19 can be configured by, for example, a storage device such as a random access memory (RAM), a solid state drive (SSD), a hard disk drive (HDD), or a read only memory (ROM).

In the first embodiment, the storage 19 stores a control program 191, a display control program 192, a display mode determination program 193, and a job control program 195, and secures an object storage area 194.

The control program 191 is a program that is read by the controller 11 when comprehensively controlling the display apparatus 10 and the multifunction peripheral 100. The controller 11 that has read the control program 191 controls the driving of hardware such as the display 13, the operation inputter 15, the communicator 17, and the image processor 21.

The display control program 192 is a program that is read by the controller 11 when performing output control of an operation screen that is displayed by the display 13 or the operation inputter 15 configured as a touch panel. The controller 11 that has read the display control program 192 controls the display of operation screens such as a home screen, settings screens related to execution of each job, and a history information screen. Furthermore, the controller 11 that has read the display control program 192 performs a display control of an additional display based on a display mode determined based on the display mode determination program 193.

The display mode determination program 193 is a program that is read by the controller 11 when determining the display mode of an additional display. The controller 11 that has read the display mode determination program 193 performs control of the display position of the additional display and the number of lines of the character string to display when the display of the additional display overlaps a restricted region that restricts the display of the additional display. Note that the restricted region according to the present disclosure includes (i) a region secured on the operation screen in order to display objects, such as objects related to the display of important information and objects that accept inputs of important setting values and the like from the user, whose display on the operation screen is protected (hereinafter, in the present disclosure, such objects are referred to as protected objects), (ii) a region in which the display of the additional display itself is restricted (a predetermined region described below), and (iii) a region outside the displayable region of the touch panel (screen), and regions in which the controller 11 restricts the display of the additional display.

For example, in the present disclosure, it is assumed that the title character string of each operation screen is a protected object whose display is protected. Furthermore, for example, the protected objects can also be an objects that display important information or accept an input of important setting values and the like, such as the number of copies on a “copy” screen, a fax number that has been input on a “fax” screen, a transmission destination address that has been input on a “scan” screen, and a transmission history on a “transmission history” screen, each of which serve as operation screens.

The object storage area 194 is a storage area that stores image information of the objects that are displayed on an operation screen. The controller 11 that has read the display control program 192 performs a display control of the objects constituting an operation screen based on the image information of the objects stored in the object storage area 194.

The job control program 195 is a program that is read by the controller 11 when a printing job related to printing or copying, or a job related to fax or image transmission is executed. The controller 11 that has read the job control program 195 transitions to a job mode (a printing mode, a copying mode, a fax mode, or an image transmission mode) for executing each job, and executes the job. Note that, when executing a job, the controller 11 displays, as an operation screen on the touch panel, a job settings screen that accepts setting values required for execution of the job, and selection of functions from the user, as necessary. The controller 11 executes each job based on the setting values and functions that have been accepted via the job settings screen.

The image processor 21 includes an image former 211 and an image inputter 213. The image former 211 supplies a paper sheet from a sheet feeder 25, forms an image based on image data on the paper sheet, and then discharges the paper sheet to a paper discharger 27. The image former 211 may be configured by, for example, a laser printer using an electrophotographic method. In this case, the image former 211 forms images by using toner supplied from toner cartridges (not shown) corresponding to toner colors (for example, cyan, magenta, yellow, and black).

The image inputter 213 generates image data by scanning a document. The image inputter 213 can be configured as a scanner device having, in addition an image sensor such as a charge coupled device (CCD) or a contact image sensor (CIS), an automatic document feeder (ADF), and a flat bed on which a document is placed and read. The configuration of the image inputter 213 is not particularly limited as long as the configuration allows image data to be generated by reading a reflected light image from a document image with the image sensor. Note that the image inputter 213 can also be configured as an interface that is capable of acquiring, for example, image data stored in a storage medium such as a USB memory, or image data transmitted from an external terminal device (not shown). In addition, the image processor 21 may be of a mode in which, for example, shading corrections and density corrections are performed with respect to image data that has been input from the image inputter 213 to generate image data for transmission.

### 1.2 Processing Flow

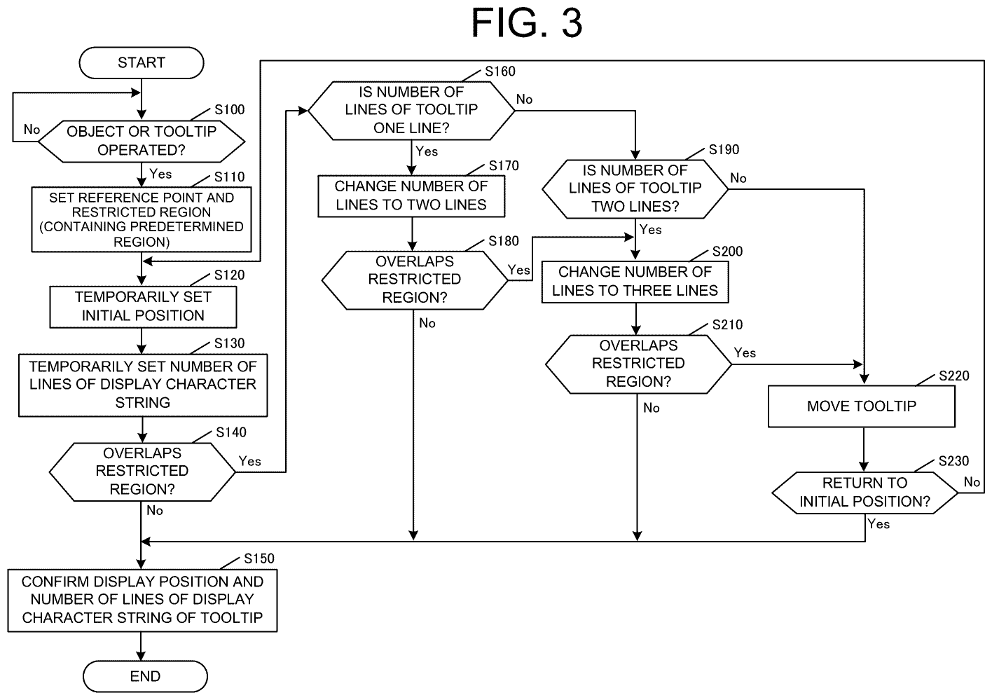

Next, a processing flow according to the first embodiment will be described. FIG. 3 is a flowchart illustrating processing that, in response to detecting an operation with respect to an object or additional display, confirms the display position and display character string, which represent the display mode of the additional display. Note that the processing illustrated in FIG. 3 is processing executed as a result of the controller 11 reading the display control program 192, the display mode determination program 193, and the like.

The additional display according to the first embodiment is a display mode in which a display of predetermined information, or information about a protected object related to an input field or the like, are displayed in a supplementary fashion. The additional display is known, for example, as a display mode such as a tooltip or a balloon. The additional display may be displayed as a rectangle display or a balloon display. Furthermore, the additional display may be displayed as a pop-up. Hereinafter, a rectangular tooltip will be described as one mode of the additional display.

The controller 11 determines whether or not an operation with respect to an object or tooltip has been detected via an operation screen displayed on the operation inputter 15, which is configured as a touch panel (step S100).

If the controller 11 detects an operation with respect to the object or tooltip, the controller 11 sets a reference point of the tooltip and a restricted region containing a predetermined region centered at the reference point based on the acquired coordinate information of the touch panel (step S100; Yes→step S110). Note that, if it is determined that an operation with respect to the object or tooltip has not been detected, the controller 11 waits until an operation with respect to the object or tooltip is detected (step S100; No).

The controller 11 temporarily sets an initial position of the display position of the tooltip (step S120). Further, the controller 11 temporarily sets the number of lines of the display character string of the tooltip (step S130).

Then, the controller 11 determines whether or not the display of the tooltip overlaps a restricted region (step S140). Here, the phrase “display of the tooltip overlaps a restricted region” according to the present disclosure represents a phenomenon in which a display region (coordinate position) secured for displaying the tooltip is partially or completely stacked on a display region (coordinate position) secured as a display region of a protected object or the tooltip itself, which results in the complete display of the protected object or the like not being maintained (protected).

If it is determined that the display of the tooltip does not overlap a restricted region, the controller 11 confirms the display position and the number of lines of the display character string of the tooltip, and ends the processing (step S140; No→step S150).

On the other hand, if it is determined that the display of the tooltip overlaps a restricted region, the controller 11 determines whether or not the number of lines of the display character string of the tooltip is one line (step S140; Yes→step S160). If it is determined that the number of lines of the display character string of the tooltip is one line, the controller 11 changes the number of lines of the display character string to two lines (step S160; Yes→step S170).

Then, the controller 11 determines whether or not the display of the tooltip overlaps a restricted region (step S180). If it is determined that the display of the tooltip does not overlap a restricted region, the controller 11 confirms the display position and the number of lines of the display character string of the tooltip, and ends the processing (step S180; No→step S150). On the other hand, if it is determined that the display of the tooltip overlaps a restricted region, the controller 11 shifts the processing to step S200 (step S180; Yes→step S200).

In addition, in step S160, if it is determined that the number of lines of the display character string of the tooltip is not one line, the controller 11 determines whether or not the number of lines of the display character string is two lines (step S160; No→step S190). If it is determined that the number of lines of the display character string of the tooltip is two lines, the controller 11 changes the number of lines of the display character string to three lines (step S190; Yes→step S200).

Then, the controller 11 determines whether or not the display of the tooltip overlaps a restricted region (step S210). If it is determined that the display of the tooltip does not overlap a restricted region, the controller 11 confirms the display position and the number of lines of the display character string of the tooltip, and ends the processing (step S210; No→step S150). On the other hand, if it is determined that the display of the tooltip overlaps a restricted region, the controller 11 shifts the processing to step S220 (step S210; Yes→step S220).

The controller 11 performs processing related to moving the tooltip (step S220). Then, the controller 11 determines whether or not the tooltip has returned to the initial position (step S230). If it is determined that the tooltip has returned to the initial position, the controller 11 confirms the display position and the number of lines of the display character string of the tooltip, and ends the processing (step S230; No→step S150). On the other hand, if it is determined that the tooltip has not returned to the initial position, the controller 11 shifts the processing to step S120 (step S230; No→step S120).

### 1.3 Operation Example

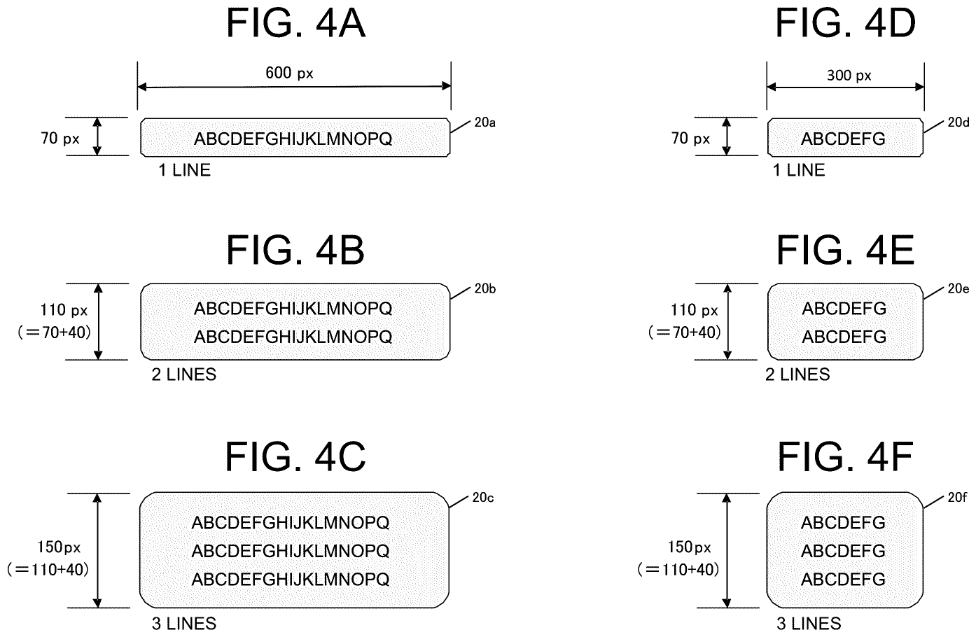

Next, an operation example according to the first embodiment will be described. FIGS. 4A to 4F are each a diagram describing the display size and the number of lines of the display character string of a tooltip 20 that can be displayed on the multifunction peripheral 100 (display apparatus 10) according to the first embodiment.

FIG. 4A is a diagram illustrating a tooltip 20a having a display size with a horizontal width 600 pixels×vertical width 70 pixels. The tooltip 20a is an example of a tooltip that is capable of displaying a “one line” character string of 17 full-width characters.

FIG. 4B is a diagram illustrating a tooltip 20b having a display size with a horizontal width 600 pixels×vertical width 110 pixels (70 pixels+40 pixels). The tooltip 20b is an example of a tooltip that is capable of displaying a “two line” character string of 17 full-width characters.

FIG. 4C is a diagram illustrating a tooltip 20c having a display size with a horizontal width 600 pixels×vertical width 150 pixels (110 pixels+40 pixels). The tooltip 20c is an example of a tooltip that is capable of displaying a “three line” character string of 17 full-width characters.

FIG. 4D is a diagram illustrating a tooltip 20d having a display size with a horizontal width 300 pixels×vertical width 70 pixels. The tooltip 20d is an example of a tooltip that is capable of displaying a “one line” character string of 7 full-width characters.

FIG. 4E is a diagram illustrating a tooltip 20e having a display size with a horizontal width 300 pixels×vertical width 110 pixels (70 pixels+40 pixels). The tooltip 20e is an example of a tooltip that is capable of displaying a “two line” character string of 7 full-width characters.

FIG. 4F is a diagram illustrating a tooltip 20f having a display size with a horizontal width 300 pixels×vertical width 150 pixels (110 pixels+40 pixels). The tooltip 20f is an example of a tooltip that is capable of displaying a “three line” character string of 7 full-width characters.

Note that, for example, “changing the number of lines to two lines” in step S170 and the like of the flowchart of FIG. 3 refers to changing the display of the tooltip 20 from the tooltip 20a (one line display) to the tooltip 20b (two line display) as illustrated in FIGS. 4A to 4F. In the processing according to the flowchart of FIG. 3, the controller 11 controls the switching of the displayed tooltip 20 (20a to 20f) based on the display size and the number of lines of the display character string that have been determined.

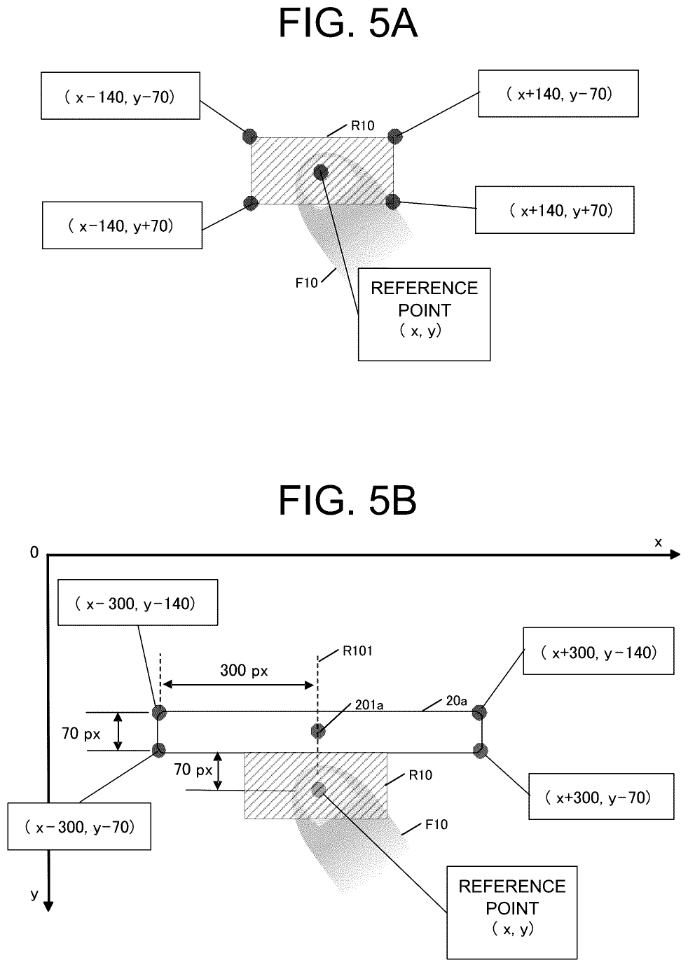

Next, FIG. 5A is a diagram illustrating a predetermined region R10 centered at a reference point (herein, referred to as a predetermined region). The predetermined region R10 is centered at the reference point (x, y), which is the operation position by a user's finger F10, and is a region that is set as a predetermined region (reference region) having a predetermined area (for example, a horizontal width 280 pixels×vertical width 140 pixels) that restricts the display of a tooltip. When the tooltip is displayed in a surrounding region having the operation position by the user as the reference point, the tooltip is covered by the user's finger F10. As a result, the tooltip becomes difficult to see. Therefore, by setting the surrounding region of the reference point as a predetermined region that restricts the display of the tooltip, the visibility of the tooltip can be maintained. Note that, in FIG. 5A, the display area of the predetermined region R10 is a rectangular area having a horizontal width 280 pixels×vertical width 140 pixels. However, the setting of the display area and shape of the predetermined region R10 can be changed as appropriate in consideration of the displayable area of the touch panel and the like.

FIG. 5B is a diagram illustrating the display position (initial position) of a tooltip that is displayed by the controller 11 when the user's finger F10 operates an object. In FIG. 5B, the tooltip 20a illustrated in FIG. 4A will be used in the description as an example of a tooltip.

The display position of the tooltip 20a has, as an initial position, a position that touches the upper edge (outer periphery) of the predetermined region R10, which has the operation position by the user's finger F10 as the reference point. This is because, if the display position of the tooltip 20a is below the predetermined region R10, the tooltip 20a becomes covered by the user's finger F10, making the tooltip 20a difficult to see.

The tooltip 20a is arranged such that a center point 201a of the rectangle is positioned on an extension line R101 of the reference point (x, y). Further, if the display of the tooltip 20a at the display position (arranged position) overlaps the restricted region that restricts the display of the tooltip 20a, the controller 11 changes the display mode of the tooltip 20a.

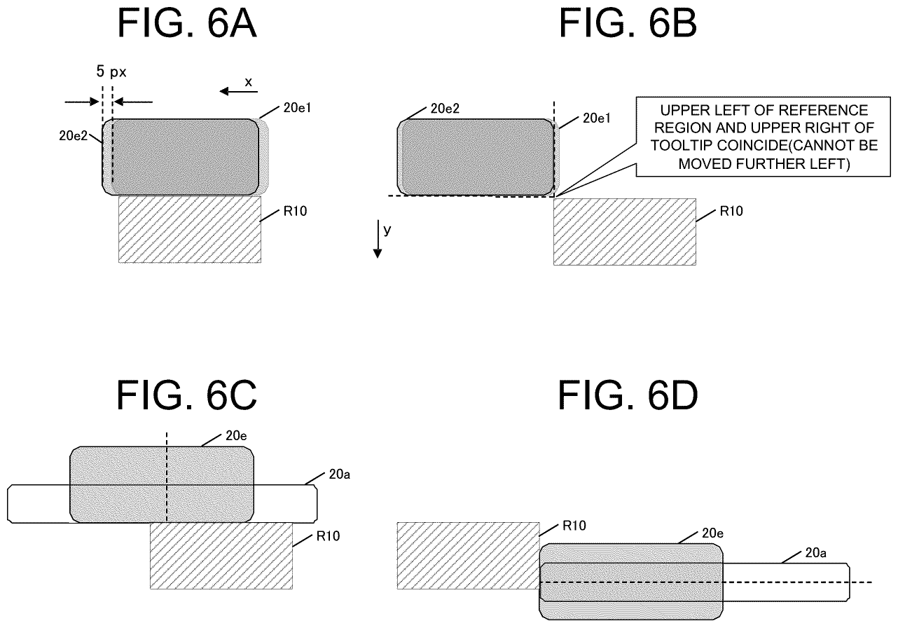

Next, an example of changing the display mode of a tooltip will be described. FIGS. 6A and 6B are each diagrams illustrating a control related to movement of a tooltip as an example of changing the display mode of a tooltip. Furthermore, FIGS. 6C and 6D are each diagrams illustrating a control related to changing the number of lines of the display character string of a tooltip. Note that, in FIGS. 6A to 6D, the tooltip 20e illustrated in FIG. 4E will be used in the description as an example of a tooltip.

For example, when the display of the tooltip 20e overlaps the restricted region, the controller 11 performs a control that moves the tooltip 20e along the outer periphery of the predetermined region R10 in an anticlockwise direction (negative x-axis direction) represented by the direction of the arrow in the diagram (FIG. 6A). FIG. 6A shows a state in which the x-coordinate of a tooltip 20e1 has been moved by 5 pixels in the direction of the arrow in the diagram (tooltip 20e2).

FIG. 6B shows a state in which, due to the movement of the tooltip 20e1 illustrated in FIG. 6A (tooltip 20e2), the right edge of the tooltip 20e1 has reached a position on an extension line of the left edge of the predetermined region R10. That is, when the display position of the left-upper corner of the predetermined region R10 and the display position of the right-lower corner of the tooltip 20e1 coincide, the controller 11 restricts the movement of the tooltip 20e1 toward the negative x-axis direction (left direction in the diagram). Note that, when the tooltip 20e1 has separated from the predetermined region R10, the controller 11 performs a control such that the movement of the x-coordinate of the tooltip 20e1 is within 5 pixels.

When the right edge of the tooltip 20e1 reaches the display position shown in FIG. 6B, the controller 11 continues the movement of the tooltip 20e1 in the positive y-axis direction (the downward direction in the diagram) in units of 5 pixels. The controller 11 continues the control related to the movement of the tooltip 20e1 until the display of the tooltip 20e1 is in a position that does not overlap the restricted region. Note that, in FIGS. 6A and 6B, the movement direction of the tooltip 20e is set in the anticlockwise direction with a right-handed user in mind. On the other hand, in the case of a left-handed user, it is preferable that the movement direction of the tooltip 20e is in the clockwise direction. As a result of changing the movement direction of the tooltip 20e according to the user's handedness, it is possible to prevent the tooltip from being covered by the user's finger as the user's finger moves.

FIG. 6C is a diagram illustrating a control that changes the number of lines of the display character string of the tooltip 20a from “one line” to “two lines” (tooltip 20e) when the tooltip 20a is touching the upper edge of the predetermined region R10 along the x-axis. Note that, when changing the number of lines of the display character string from “one line” to “two lines”, the controller 11 maintains the position of the corresponding central axis (dotted line in the diagram) of the tooltip 20a and the tooltip 20e.

FIG. 6D is a diagram illustrating a control that changes the number of lines of the display character string of the tooltip 20a from “one line” to “two lines” (tooltip 20e) when the tooltip 20a is touching the right edge of the predetermined region R10 along the y-axis. Note that, when changing the number of lines of the display character string from “one line” to “two lines”, in a similar manner to FIG. 6C, the controller 11 maintains the position of the corresponding central axis (dotted line in the diagram) of the tooltip 20a and the tooltip 20e.

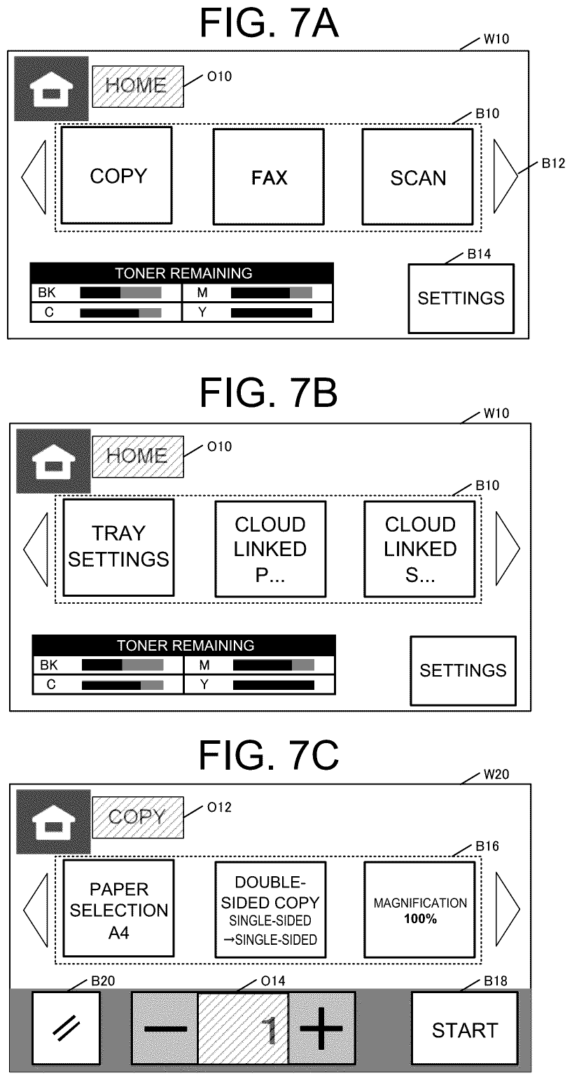

Next, a configuration example of an operation screen according to the first embodiment will be described. FIG. 7A is a diagram illustrating a display configuration example of a home screen W10 serving as an operation screen. The home screen W10 illustrated in FIG. 7A and the like is displayed, for example, on the touch panel (operation inputter 15) on powering up, during standby, and upon recovery from a sleep state, and can be configured as an operation screen that accepts operation inputs from the user. Such a home screen W10 includes mode selection buttons B10, a switching button B12, a settings button B14, and a title object O10. Note that, in addition to these components, for example, a display region such as that illustrated in FIG. 7A may be provided on the home screen W10 that displays device (consumables) information such as the amount of remaining toner.

The mode selection buttons B10 are selection buttons that accept a selection of an operation mode related to execution of a job, and are buttons that accept, for example, a display instruction of an address book that manages the destination information and the like related to an image transmission job, a settings history for executed jobs, and the like. FIG. 7A illustrates an example in which a “copy” button, a “fax” button, and a “scan” button are selectably displayed as the mode selection buttons B10. When the controller 11 receives a user selection, for example, of the “copy” button, the controller 11 switches the operation mode of the multifunction peripheral 100 to the copy mode, and also displays on the touch panel a copy settings screen (FIG. 7C) that accepts an execution instruction of a copy job. The switching button B12 is a button that accepts an input of an instruction that switches the selection buttons displayed as the mode selection buttons B10. The settings button B14 is a button that accepts a display instruction of a settings screen (not shown) related to the device settings of the multifunction peripheral 100.

The title object O10 is a protected object that displays the title character string “Home” of the home screen W10. If the display of the tooltip overlaps (is stacked on) the display of the title object O10, the controller 11 changes the display mode of the tooltip.

FIG. 7B is a diagram illustrating a display configuration of the home screen W10 that, as a result of the user selecting the switching button B12, is displaying different mode selection buttons B10 to those displayed in FIG. 7A.

FIG. 7B is an example illustrating, as the mode selection buttons B10, the display of a “tray settings” button, a “cloud linked p . . . ” button (where the characters following “cloud linked p” in the phrase “cloud linked printing application” are represented by an ellipsis character “ . . . ”), and a “cloud linked s . . . ” button (where the characters following “cloud linked s” in the phrase “cloud linked scanning application” are represented by an ellipsis character “ . . . ”). Note that, because the “cloud linked p . . . ” button and the “cloud linked s . . . ” button have a character string that has been omitted by the ellipsis character, they are objects that are subjected to display of a tooltip that displays the entire character string including the omitted characters (string) as a result of the user performing an operation such as a mouseover.

FIG. 7C is a diagram illustrating a display configuration example of a copy settings screen W20 displayed by the controller 11 after a selection has been received of the “copy” button serving as a mode selection button B10 on the home screen W10. The copy settings screen W20 includes copy settings buttons B16, a start button B18, a reset button B20, a title object O12, and a copy count object O14.

The copy settings buttons B16 are buttons that accept selection and input of setting items (setting values) related to execution of a copy job. FIG. 7C illustrates the display of a “paper selection” button, a “double-sided copy” button, and a “magnification” button as setting items related to execution of a copy job, together with the setting values (for example, paper selection: A4).

The start button B18 is a button that accepts an input of an execution instruction of a copy job. When a selection of the start button B18 is accepted, the controller 11 executes a copy job based on the setting content that has been set via the copy settings screen W20. Furthermore, the reset button B20 is a button that accepts a reset instruction of the content that has been input and set via the copy settings screen W20.

The title object O12 is a protected object that displays the title character string “Copy” of the copy settings screen W20. The copy count object O14 is a protected object that accepts an input of the number of copies from the user. If the display of the tooltip overlaps the display of the title object O12 or the copy count object O14, the controller 11 changes the display mode of the tooltip.

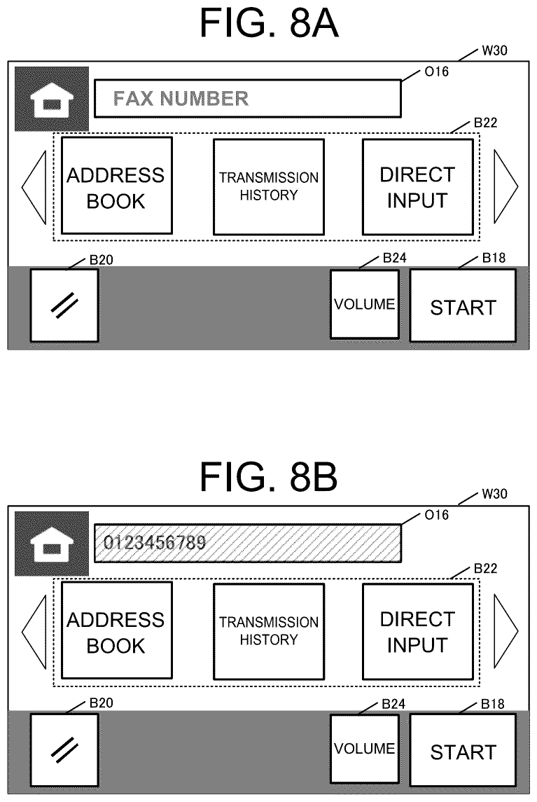

FIG. 8A is a diagram illustrating a display configuration example of a fax settings screen W30 displayed by the controller 11 after a selection has been received of the “fax” button serving as a mode selection button B10 on the home screen W10. The fax settings screen W30 includes fax settings buttons B22, a start button B18, a reset button B20, a volume button B24, and a fax number input object O16. Note that configurations that can be made the same as those of the home screen W10 and the copy settings screen W20 and the like described previously are denoted by the same reference numerals, and the descriptions may be omitted.

The fax settings buttons B22 are buttons that accept selection and input of setting items (setting values) related to execution of a fax job. FIG. 8A illustrates an example of displaying, as setting items related to execution of a fax job, an “address book” button, a “transmission history” button, and a “direct input” button.

The volume button B24 is a button that accepts a setting of a transmission and reception volume used when transmitting or receiving a fax. The fax number input object O16 is an object that accepts selection and input of a fax number for a fax transmission. The input of a fax number to the fax number input object O16 can be performed by making a selection from the address book displayed by selection of the “address book” button, making a selection from the transmission history displayed by selection of the “transmission history” button, or making a direct input using software keys, hardware keys, or the like displayed by selection of the “direct input” button.

Note that FIG. 8B is a diagram showing a state where a fax number has been input to the fax number input object O16 by the user. When even a part of the fax number is input to the fax number input object O16 by the user (for example, “0123456789”), the fax number input object O16 is treated as a protected object. If the display of the tooltip overlaps the fax number input object O16 after a fax number has been entered, the controller 11 changes the display mode of the tooltip.

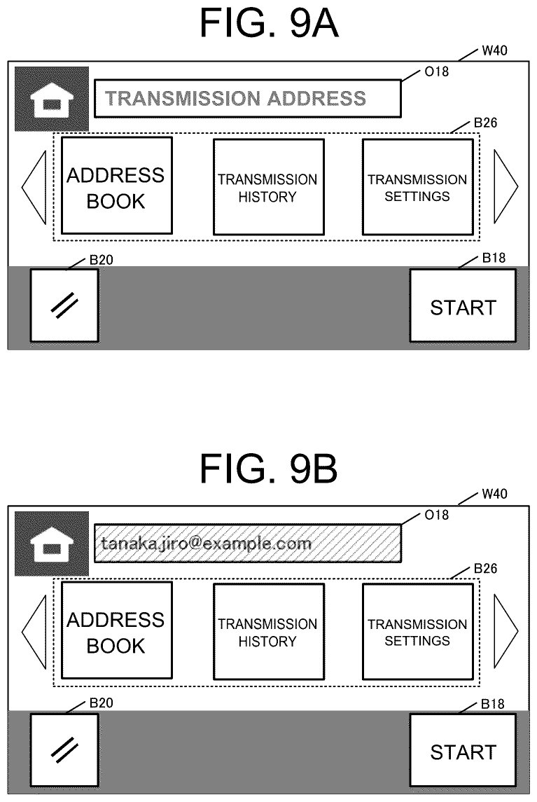

FIG. 9A is a diagram illustrating a display configuration example of a scan settings screen W40 displayed by the controller 11 after a selection has been received of the “scan” button serving as a mode selection button B10 on the home screen W10. The scan settings screen W40 includes scan settings buttons B26, a start button B18, a reset button B20, and a destination input object O18. Note that configurations that can be made the same as those of the home screen W10 and the copy settings screen W20 and the like described previously are denoted by the same reference numerals, and the descriptions may be omitted.

The scan settings buttons B26 are buttons that accept selection and input of setting items (setting values) related to execution of a scan job. FIG. 9A illustrates an example of displaying, as setting items related to execution of a scan job, an “address book” button, a “transmission history” button, and a “transmission settings” button.

The destination input object O18 is an object that accepts selection and input of a transmission destination (transmission destination address) of image data generated by a scan job. The input of a transmission destination address to the destination input object O18 can be performed by making a selection from the address book displayed by selection of the “address book” button, making a selection from the transmission history displayed by selection of the “transmission history” button, or making a direct input using software keys, hardware keys, or the like displayed based on touch operations made with respect to the destination input object O18.

Note that FIG. 9B is a diagram showing a state where a transmission destination address has been input to the destination input object O18 by the user. When even a part of the transmission destination address is input to the destination input object O18 by the user (for example, “tanaka.jiro@example.com”), the destination input object O18 is treated as a protected object. If the display of the tooltip overlaps the destination input object O18 after a transmission destination address has been entered, the controller 11 changes the display mode of the tooltip.

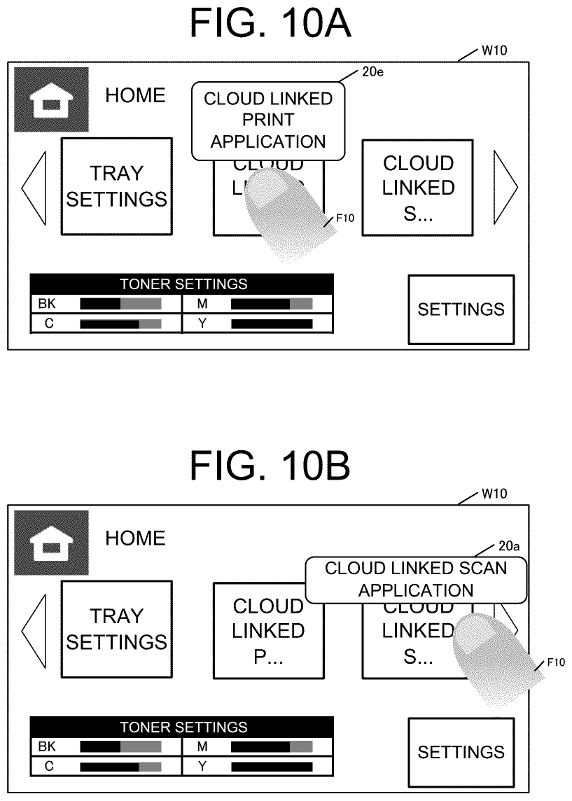

Next, a specific display example of a tooltip according to the first embodiment will be described. FIG. 10A is a diagram illustrating a display example of the tooltip 20e displayed by the controller 11 when, on the home screen W10 shown in FIG. 7B, for example, the “cloud linked p . . . ” button serving as a mode selection button B10 is pressed and held by the user's finger F10 or a mouseover is performed. FIG. 10A illustrates an example where the tooltip has not been moved, but the display mode of the tooltip 20a has been changed from that of the tooltip 20a, in which the number of lines of the display character string is “one line”, to that of the tooltip 20e, in which the number of lines is “two lines”.

On the other hand, FIG. 10B is a diagram illustrating a display example of the tooltip 20a displayed by the controller 11 when, on the home screen W10 shown in FIG. 7B, for example, the “cloud linked s . . . ” button serving as a mode selection button B10 is pressed and held by the user's finger F10 or a mouseover is performed. FIG. 10A illustrates an example where the tooltip 20a has been moved toward the left direction (anticlockwise direction) because the display of the tooltip 20a overlaps a restricted region outside the displayable region of the touch panel (screen).

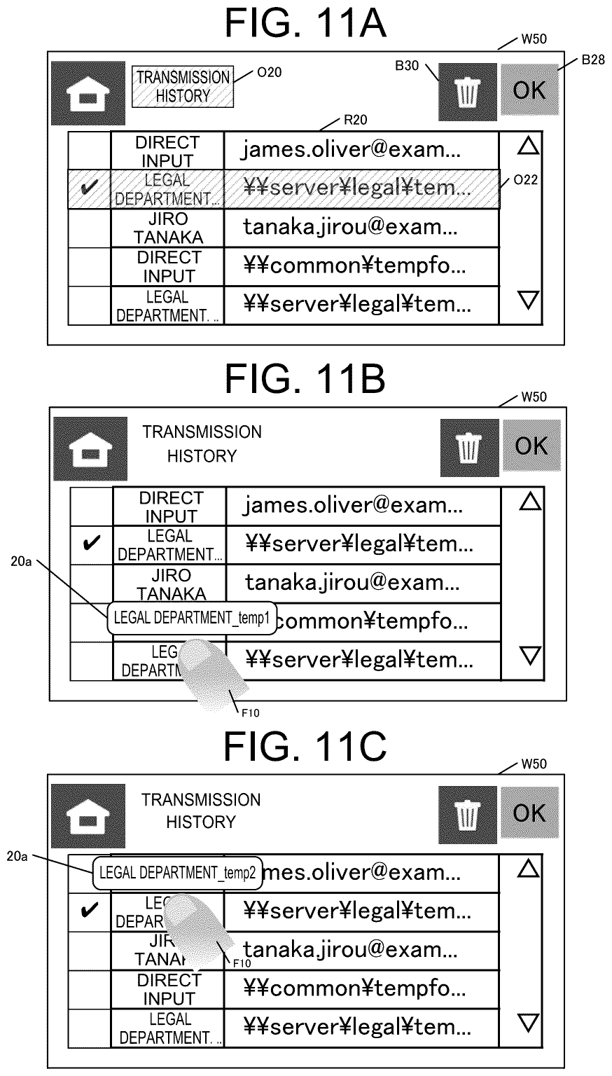

Next, FIGS. 11A to 11C are each diagrams illustrating an example of display configuration of a transmission history screen W50 displayed by the controller 11 when the “transmission history” button serving as a scan settings button B26 on the scan settings screen W40 of FIG. 9A is selected by the user. The transmission history screen W50 includes a transmission history display region R20, an OK button B28, a delete button B30, a title object O20, and a selected transmission destination object O22.

The transmission history display region R20 is a display region that displays the destinations (transmission destination addresses) of image data generated by scan jobs as a transmission history. The OK button B28 is a button that accepts an input of a confirmation instruction of the transmission destination address selected in the transmission history display region R20. When a check mark is added to the transmission history display region R20 for a transmission history that has been selected by the user (selected transmission destination object O22), and the OK button B28 is selected by the user, the controller 11 sets the transmission destination address specified by the transmission history to the destination input object O18 illustrated in FIG. 9A and the like. Then, when a selection of the start button B18 by the user is accepted, the controller 11 transmits the image data to the transmission destination address that is set in the destination input object O18.

The delete button B30 is a button that accepts a delete instruction of a transmission history from the transmission history display region R20. When a check mark is added to the transmission history display region R20 for a transmission history that has been selected by the user (selected transmission destination object O22), and the delete button B30 is selected by the user, the controller 11 stops displaying the transmission history in the transmission history display region R20. In this case, the controller 11 may perform a control that deletes the history information related to the transmission history from the storage 19.

The title object O20 is a protected object that displays the title character string “Transmission History” of the transmission history screen W50. The selected transmission destination object O22 is a protected object related to the transmission history that has been selected by the user to which a check mark has been added that indicates the selection. If the display of the tooltip overlaps the display of the title object O20 or the selected transmission destination object O22, the controller 11 changes the display mode of the tooltip.

FIG. 11B is a diagram illustrating a display example of the tooltip 20a displayed by the controller 11 when the transmission history “legal department . . . ” displayed on the bottom row of the transmission history display region R20 is, for example, pressed and held by the user's finger F10 or a mouseover is performed. Furthermore, FIG. 11C is a diagram illustrating a display example of the tooltip 20a displayed by the controller 11 when the transmission history “legal department . . . ” (selected transmission destination object O22) displayed on the second row from the top of the transmission history display region R20 is, for example, pressed and held by the user's finger F10 or a mouseover is performed.

The display of the tooltip 20a illustrated in FIGS. 11B and 11C does not overlap the restricted regions such as the title object O20 and the selected transmission destination object O22. Therefore, the tooltip 20a is displayed in a display position (initial position) above the predetermined region R10 in the original display mode, which is not accompanied by a change in the number of lines of the display character string.

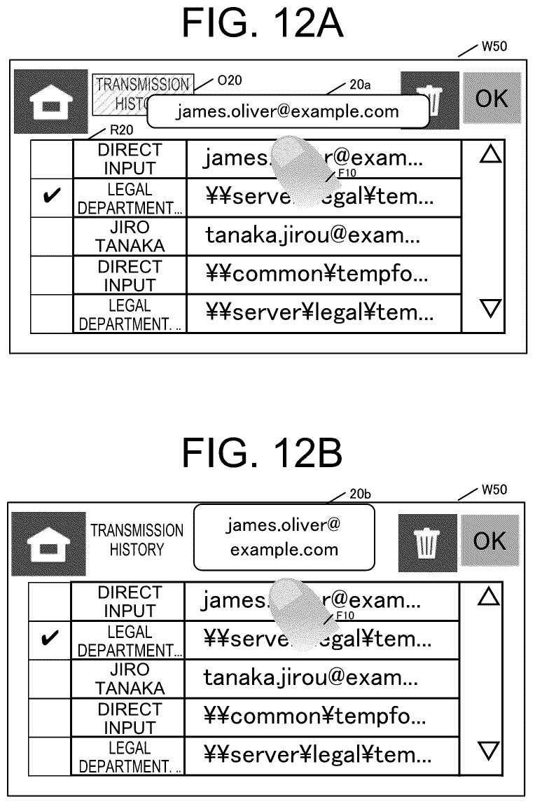

FIG. 12A is a diagram illustrating a display example of the tooltip 20a displayed by the controller 11 when the transmission history “direct input james.oliver@exam . . . ” displayed on the top row of the transmission history display region R20 is pressed and held by the user's finger F10 or a mouseover is performed.

In FIG. 12A, when an attempt is made to display the complete character string “james.oliver@example.com” in the tooltip 20a, the display of the tooltip 20a overlaps the display of the title object O20. In this case, the controller 11 changes the display mode from that of the tooltip 20a having a “one line” display character string, to that of the tooltip 20b having a “two line” display character string. As a result, as shown in FIG. 12B, the display of the title character string “Transmission History” of the title object O20, which is a protected object, is maintained without being hindered.

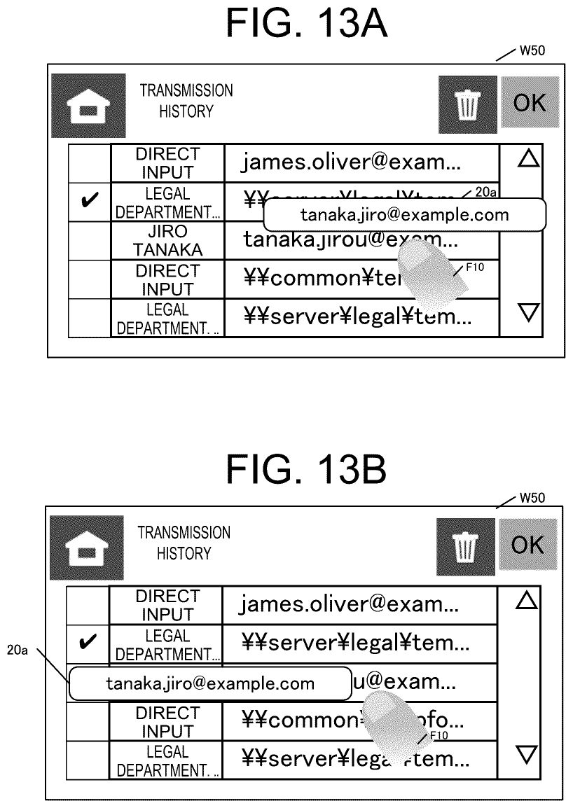

FIG. 13A is a diagram illustrating a display example of the tooltip 20a displayed by the controller 11 when the transmission history “tanaka.jiro@exam . . . ” positioned directly under the selected transmission destination object O22 is pressed and held by the user's finger F10 or a mouseover is performed.

In FIG. 13A, when an attempt is made to display the complete character string “tanaka.jiro@example.com” in the tooltip 20a, the display of the tooltip 20a overlaps the display of the selected transmission destination object O22. In this case, the controller 11 changes the display mode by moving the tooltip 20a in an anticlockwise direction. As a result, as shown in FIG. 13B, the display of the selected transmission destination object O22, which is a protected object, is maintained without being hindered.

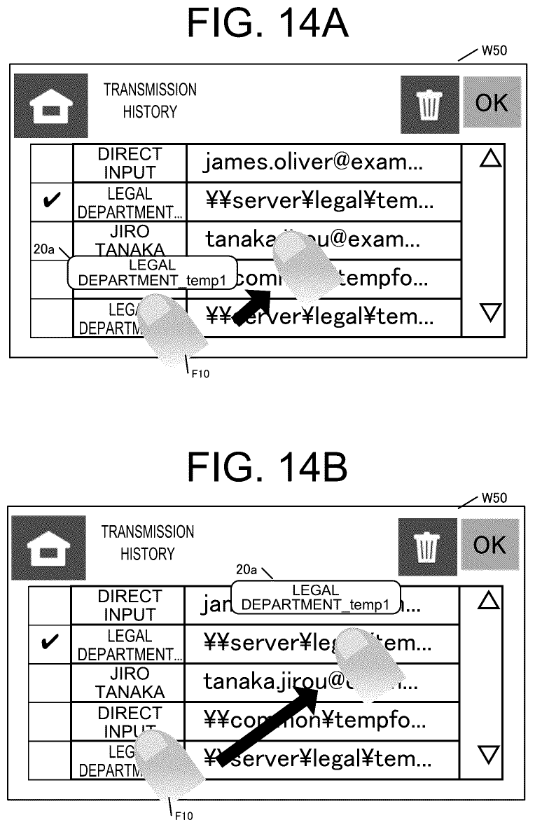

FIG. 14A illustrates a case where a drag is performed toward the right-upper direction while the tooltip 20a is displayed. The controller 11 determines the display position (coordinates) and the number of lines of the display character string of the tooltip 20a each time movement of the tooltip 20a is detected. At the beginning of the movement, the tooltip 20a moves while maintaining the display directly above the user's finger F10 so as to follow the movement of the user's finger F10. However, midway through the drag, the display position is determined to be the lower side of the selected transmission destination object O22 so as to not overlap the restricted region of the selected transmission destination object O22.

FIG. 14B illustrates a case where a drag is performed further toward the right-upper direction from the position in FIG. 14A. The controller 11 determines the display position (coordinates) and the number of lines of the display character string of the tooltip 20a each time movement of the tooltip 20a is detected. As a result, when the tooltip 20a no longer overlaps the display of the selected transmission destination object O22, the display position returns to a display position directly above the user's finger F10.

As described above, according to the first embodiment, when the display of a tooltip serving as an additional display overlaps a restricted region that restricts the display of the tooltip, it is possible to move the tooltip or change the number of lines of the display character string of the tooltip. As a result of such a configuration, it is possible to prevent the display of a tooltip from resulting in the tooltip covering an object. Therefore, the visibility of the object can be maintained.

### 2. Second Embodiment

The first embodiment is a mode in which the display position of a tooltip and the number of lines of a character string to be displayed are changed when a tooltip serving as an additional display overlaps a restricted region. A second embodiment will be described in which a transparency control of the display of a tooltip is performed as an example of a change in the display mode of a tooltip.

Because the functional configuration of the multifunction peripheral 100 implementing the display apparatus 10 according to the second embodiment can be made the same as the functional configuration according to the first embodiment, the description will be omitted here.

### 2.1 Processing Flow

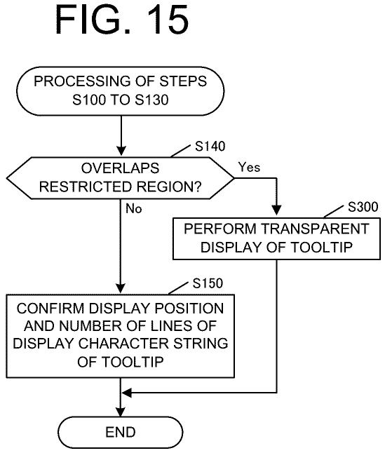

The processing flow according to the second embodiment can be a flow in which the flowchart of FIG. 3 of the first embodiment is replaced by the flowchart of FIG. 15. Furthermore, the processing that can be made common with the processing illustrated in FIG. 3 is denoted by the same step numbers and the description is omitted.

In the flowchart of FIG. 15, after completing the processing from steps S100 to S130, the controller 11 determines whether or not the display of the tooltip overlaps a restricted region (step S140). If it is determined that the display of the tooltip does not overlap a restricted region, the controller 11 confirms the display position and the number of lines of the display character string of the tooltip, and ends the processing (step S140; No→step S150).

On the other hand, if it is determined that the display of the tooltip overlaps a restricted region, the controller 11 performs a transparent display of the tooltip and ends the processing (step S140; Yes→step S300).

### 2.2. Operation Example

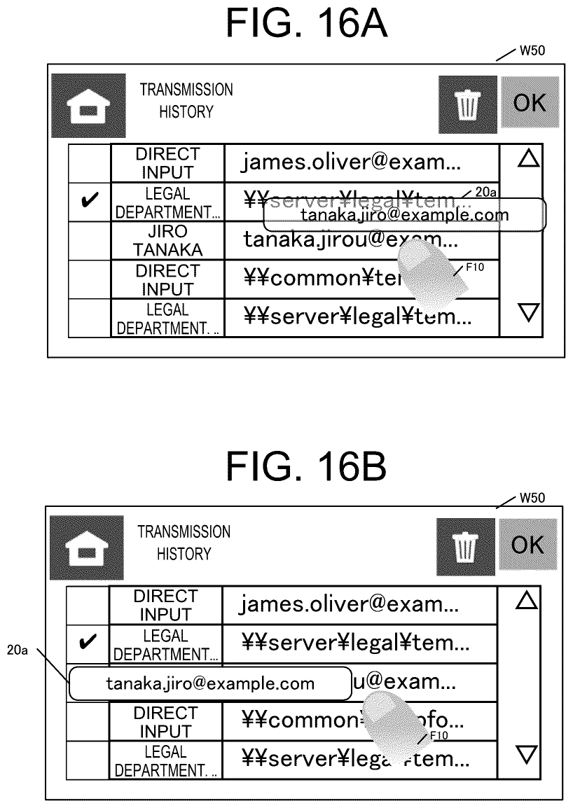

FIG. 16A is the same diagram as the diagram described in the operation example of FIG. 13A according to the first embodiment, and is a diagram reflecting a transparent display of the tooltip 20a according to the second embodiment. Note that, a transparent display (control) according to the second embodiment refers to changing (increasing) the transparency of the tooltip 20a to an extent that, when the tooltip 20a overlaps the restricted region of the selected transmission destination object O22 and the like, allows the display content of the selected transmission destination object O22 to be distinguished. The specific transparency applied to the tooltip 20a can be appropriately changed according to the default display settings applied to the tooltip 20a, and can be semi-transparent as long as the transparency allows the display content of the selected transmission destination object O22, which is a protected object, to be distinguished.

As illustrated in FIG. 16A, by performing a transparent display of the tooltip 20a, it is possible to confirm the display content of the selected transmission destination object O22, which is a protected object, through the tooltip 20a.

In addition, the transparent display (control) according to the second embodiment can be combined with the movement processing of the tooltip 20a according to the first embodiment. That is, for example, it is possible to perform a transparent display of the displayed tooltip 20a when the transmission history “tanaka.jiro@exam . . . ” positioned directly under the selected transmission destination object O22 is pressed and held by the user's finger F10 or a mouseover is performed (see FIG. 13A), and to return to the original display mode by removing the transparent display of the tooltip 20a after movement of the tooltip 20a (FIG. 16B).

As described above, according to the second embodiment, as in the first embodiment, when the display of a tooltip serving as an additional display overlaps a restricted region which restricts the display of the tooltip, it is possible to maintain the visibility of an object even when the tooltip covers the object by performing a transparent display of the tooltip.

### 3. Third Embodiment

A third embodiment is a mode in which, after changing the display mode of a tooltip serving as an additional display in the first embodiment, the display of the tooltip ends after a predetermined time elapses. Here, for example, the predetermined time may be several seconds, as long as the time scale is of a level that allows the user to confirm all of the display contents (the entire character string) of the tooltip.

Because the functional configuration of the multifunction peripheral 100 implementing the display apparatus 10 according to the third embodiment can be made the same as the functional configuration according to the first embodiment, the description will be omitted here.

### 3.1 Processing Flow

The processing flow according to the third embodiment is a flow in which processing has been added to the flowchart of FIG. 3 according to the first embodiment. Therefore, a description of the same processing will be omitted.

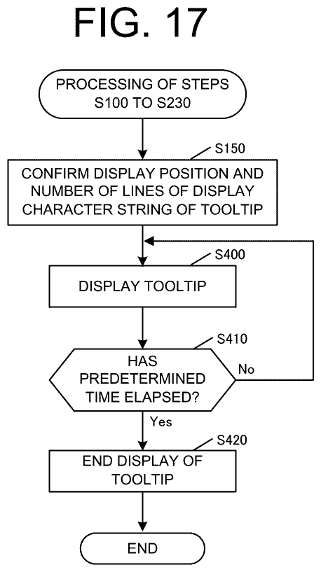

FIG. 17 is a flowchart illustrating a flow of processing according to the third embodiment.

After the processing of steps S100 to S230 according to FIG. 3, the controller 11 confirms the display position of the tooltip and the number of lines in the display character string (step S150).

Then, the controller 11 displays the tooltip (step S400). Further, the controller 11 determines whether or not a predetermined time has elapsed since starting the display of the tooltip (step S410).

If it is determined that the predetermined time has elapsed since starting the display of the tooltip, the controller 11 ends the display of the tooltip (step S410; Yes→step S420). On the other hand, if it is determined that the predetermined time has not elapsed since starting the display of the tooltip, the controller 11 continues to display the tooltip (step S410; No→step S400).

As described above, according to the third embodiment, in addition to the effects of the first embodiment, because the display of the tooltip whose display mode has been changed is restricted (removed) after a predetermined time elapses from the start of the display of the tooltip, for example, it is possible to prevent the visibility of other objects that are covered after the tooltip is moved from being reduced for a long period of time.

The present disclosure is not limited to the embodiments described above, and various modifications are possible. That is, the technical scope of the present disclosure also includes embodiments that may be obtained by combining technical means that are modified as appropriate within a scope not departing from the gist of the present disclosure.

Although some parts of the foregoing embodiments have been described separately for convenience of the description, it is needless to say that such embodiments may be combined and implemented within a technically allowable range.

Furthermore, a program that operates on each device in the embodiments is a program that controls a CPU or the like (a program that causes a computer to function) so as to realize the functions of the embodiments described above. In addition, the information handled by the devices is temporarily stored in a temporary storage device (for example, a RAM) during processing, and then stored in various storage devices such as a ROM or an HDD, and read, corrected, and written by the CPU as required.

Here, the computer-readable non-transitory recording medium in which the program is recorded in the information processing device may be any of a semiconductor medium (for example, a ROM or a non-volatile memory card), an optical recording medium or magneto-optical recording medium (for example, a digital versatile disc (DVD), a magneto-optical disc (MO), a mini disc (MD), a compact disc (CD), or a Blu-ray disc (BD (registered trademark)), a magnetic recording medium (for example, a magnetic tape or a flexible disk), or the like. In this case, the functions of the embodiments described above are not only realized as a result of the program recorded in the recording medium being read by the computer of the information processing device and executed by the computer, but the functions of the present disclosure are realized as a result of cooperative processing with an operating system or other application programs or the like based on the instructions of the program.

Furthermore, in the case of distribution to the market, the program can be stored and distributed in a portable recording medium, or transferred to a server computer connected via a network such as the Internet. In this case, it is needless to say that a storage device of the server computer is also included in the present disclosure.

In addition, each functional block or various features of the devices used in the embodiment described above can be implemented and executed by an electric circuit, such as an integrated circuit or a plurality of integrated circuits. The electric circuit designed to realize the functions described in the present specification may include a general-purpose processor, a digital signal processor (DSP), an application-specific integrated circuit (ASIC), a field-programmable gate array (FPGA), or other programmable logic devices, discrete gates or transistor logic, discrete hardware components, or a combination of these. The general-purpose processor may be a microprocessor, a conventional processor, a controller, a microcontroller, or a state machine. The electric circuit mentioned above may be configured by a digital circuit or an analog circuit. In addition, when advancements in semiconductor technology lead to the emergence of integrated circuit technologies that replace current integrated circuits, one or more of the aspects of the present disclosure may be realized using such new integrated circuits.

What is claimed is:

1. A display apparatus comprising:
a display that displays an operation screen containing one or more objects; and
one or more controllers that, based on a user operation made with respect to at least one of the one or more objects, control a display of an additional display corresponding to the at least one of the one or more objects; wherein
the one or more controllers change a display mode of the additional display when the display of the additional display overlaps a restricted region that restricts the display of the additional display.

2. The display apparatus according to claim 1, wherein
the restricted region includes a display region of one or more protected objects among the one or more objects in which a display is protected, and
the one or more controllers
protect a display of the one or more protected objects by changing the display mode of the additional display.

3. The display apparatus according to claim 1, wherein
the one or more controllers change the display mode of the additional display by changing a display position of the additional display from a reference display position.

4. The display apparatus according to claim 3, wherein
the reference display position has an operation position by the user with respect to at least one of the one or more object as a reference point, and is provided outside a predetermined region centered at the reference point, and
the one or more controllers change the display mode of the additional display such that the display of the additional display does not overlap the predetermined region.

5. The display apparatus according to claim 4, wherein
the one or more controllers change the display mode of the additional display by moving the display position of the additional display along the predetermined region.

6. The display apparatus according to claim 5, wherein
the one or more controllers change the display mode of the additional display by moving the display position of the additional display in an anticlockwise direction along the predetermined region.

7. The display apparatus according to claim 1, wherein
the one or more controllers change the display mode of the additional display by changing a number of lines of a display character string of the additional display from a reference number of lines.

8. The display apparatus according to claim 7, wherein
the one or more controllers change the display mode of the additional display by increasing or decreasing above or below the number of lines of the display character string of the additional display to or from the reference number of lines.

9. The display apparatus according to claim 1, wherein
the additional display includes a tooltip.

10. An image processing apparatus comprising: a display that displays an operation screen containing one or more objects;
one or more controllers that, based on a user operation made with respect to at least one of the one or more objects, control a display of an additional display corresponding to the at least one of the one or more objects; and
an image processor; wherein
the one or more controllers change a display mode of the additional display when the display of the additional display overlaps a restricted region that restricts the display of the additional display.

11. A display control method of an additional display that, based on a user operation made with respect to at least one of the one or more objects displayed on an operation screen, controls a display of an additional display corresponding to the at least one of the one or more objects, the method comprising:
changing a display mode of the additional display when the display of the additional display overlaps a restricted region that restricts the display of the additional display.
